(19) United States
(12) Patent Application Publication
(10) Pub. No.: US 2014/0247238 A1
(43) Pub. Date: Sep. 4, 2014

(54) SYSTEM AND METHOD FOR DUAL MODE STYLUS DETECTION

(71) Applicant: BARNESANDNOBLE.COM LLC, New York, NY (US)

(72) Inventor: Songan Andy Chang, Mountain View, CA (US)

(73) Assignee: BARNESANDNOBLE.COM LLC, New York, NY (US)

(21) Appl. No.: 13/783,010

(22) Filed: Mar. 1, 2013

(51) Int. Cl. G06F 3/044

(52) U.S. Cl. CPC G06F 3/044
USPC 345/174

(57) ABSTRACT

A system and method for improved accuracy in the detection of a stylus on a touch sensitive surface of an electronic device, such as a tablet. A dual method of detection is employed including electromagnetic induction detection of the stylus as it is in the vicinity of the screen of the electronic device, as well as capacitive detection of the stylus tip as it contacts the touch screen. The electronic device detects the presence of the top of the stylus and provides the general coordinates of its position. Then, as touches occur on the surface of the device, e.g., the stylus tip as well as the various parts of the user's hand, the system uses the coordinates supplied from the electromagnetic induction detection to very quickly and accurately pinpoint the actual location of the stylus input on the surface of the device.

### FIELD OF THE INVENTION

The present invention generally relates to devices for detecting user input on an electronic device, and more particularly to systems and methods for improved detection of a stylus on a touch sensitive surface of an electronic device.

### BACKGROUND OF THE INVENTION

Electronic devices such as cellular phones, eReaders, and tablets are fast becoming necessities, especially for people on the move. Electronic devices can be used to place phone calls, to text messages, read electronic publications to browse the Internet, to take pictures and the like.

Digitizing tablet systems are well known in the art and are used in a variety of applications, e.g., note taking. These systems generally include a tablet, a position indicating implement such as a pen or stylus and the associated electronics for producing some form of interaction between the stylus and the tablet from which is derived digital data signals representing the position of the stylus on the tablet.

The tablet typically contains a grid of conductive elements and the stylus contains an electric coil. An inductive type of interaction between the coil in the pen and the grid in tablet is achieved by energizing either the coil or the grid with an alternating current (AC) voltage signal and then measuring the voltage signal induced in the other element. In other systems, capacitive type coupling with the grid and the tablet is achieved by using a flat conductive disk at the tip of the stylus in place of the coil.

In some systems, addition to the conductive electric coil, the stylus may actually contain either a ball point pen or a pencil with the tip of the pen or the pencil terminating at the tip of the stylus. In these systems, the user can write or draw on a surface covered by a paper, as the position of the stylus is being monitored.

Since a user does not generally hold a writing implement at right angles to the tablet being written upon, the coil is not always directly over the tip of the stylus, it may be several millimeters in a lateral direction from the tip. The tilt of the stylus may thus introduce some error in the position detection. This error is commonly known as offset. To deal with the offset problem, some position indicating implements are provided with two electric coils, each being supplied with distinguishable currents. A digitizing tablet in these systems can sense the position of each of the coils and calculate the position of the tip of the stylus from the two sets of position data.

The most common technique for compensating for the offset is to estimate the distance from where the loop is detected to where the pen tip may be located. As appreciated by those skilled in the art, this approximation is good for some, but clearly not all pen based applications. Further, near the edge of any device using pen input, the detection of the coil in the stylus degrades due to blocking of the signal by the frame of the device and increased variability of where the tip may actually lie on the surface of the device.

One other significant technology enabling screen based user input is the touch screen. Although there a many technologies used to enable touchscreens, the most common are Resistive, Capacitive and Infrared. A resistive touchscreen panel comprises several layers, the most important of which are two thin, transparent, electrically-resistive layers separated by a thin space. These layers face each other, with a thin gap between. One resistive layer is a coating on the underside of the top surface of the screen. Just beneath it is a similar resistive layer on top of its substrate. One layer has conductive connections along its sides, the other along top and bottom.

When an object, such as a fingertip or stylus tip, presses down on the outer surface, the two layers touch to become connected at that point. The panel then behaves as a pair of voltage dividers, one axis at a time. For a short time, the associated electronics (device controller) applies a voltage to the opposite sides of one layer, while the other layer senses the proportion of voltage at the contact point. This provides the horizontal [x] position. Then, the controller applies a voltage to the top and bottom edges of the other layer (the one that just sensed the amount of voltage) and the first layer now senses height [y]. The controller rapidly alternates between these two modes. The controller sends the sensed position data to the CPU in the device, where it is interpreted according to what the user is doing.

Resistive touchscreens are typically used in restaurants, factories and hospitals due to their high resistance to liquids and contaminants. A major benefit of resistive touch technology is its low cost. Disadvantages include the need to press down on the screen, and a risk of damage by sharp objects. Resistive touchscreens also suffer from poorer contrast, due to having additional reflections from the extra layer of material placed over the screen.

A capacitive touchscreen panel consists of an insulator such as glass, coated with a transparent conductor such as indium tin oxide (ITO). As the human body is also an electrical conductor, touching the surface of the screen results in a distortion of the screen's electrostatic field, measurable as a change in capacitance. Different technologies may be used to determine the location of the touch. The location is then sent to the controller for processing. Unlike a resistive touchscreen, one cannot use a capacitive touchscreen through most types of electrically insulating material, such as gloves. A special capacitive stylus or a special-application glove with an embroidered patch of conductive thread passing through it and contacting the user's fingertip. This disadvantage especially affects usability in consumer electronics, such as touch tablet PCs and capacitive smartphones in cold weather.

In surface capacitance technology, only one side of the insulator is coated with a conductive layer. A small voltage is applied to the layer, resulting in a uniform electrostatic field. When a conductor, such as a human finger, touches the uncoated surface, a capacitor is dynamically formed. The sensor's controller can determine the location of the touch indirectly from the change in the capacitance as measured from the four corners of the panel. As it has no moving parts, it is moderately durable but has limited resolution, is prone to false signals from parasitic capacitive coupling, and needs calibration during manufacture.

Projected Capacitive Touch (PCT) technology is a capacitive technology which permits more accurate and flexible operation. An X-Y grid is formed either by etching a single conductive layer to form a grid pattern of electrodes, or by etching two separate, perpendicular layers of conductive material with parallel lines or tracks to form the grid (comparable to the pixel grid found in many LCD displays) that the conducting layers can be coated with further protective insulating layers, and operate even under screen protectors, or behind weather- and vandal-proof glass. Due to the top layer of a PCT being glass, it is a more robust solution than resistive touch technology. Depending on the implementation, an active or passive stylus can be used instead of or in addition to a finger. This is common with point of sale devices that require signature capture. Gloved fingers may or may not be sensed, depending on the implementation and gain settings. Conductive smudges and similar interference on the panel surface can interfere with the performance. Such conductive smudges come mostly from sticky or sweaty finger tips, especially in high humidity environments. Collected dust, which adheres to the screen due to the moisture from fingertips, can also be a problem. There are two types of PCT: Self Capacitance and Mutual Capacitance.

A PCT screen consists of an insulator such as glass or foil, coated with a transparent conductor (Copper, ATO, Nanocarbon or ITO). As the human finger, which is a conductor, touches the surface of the screen a distortion of the local electrostatic field results, measurable as a change in capacitance. Newer PCT technology uses mutual capacitance, which is the more common projected capacitive approach and makes use of the fact that most conductive objects are able to hold a charge if they are very close together. If another conductive object, in this case a finger, bridges the gap, the charge field is interrupted and detected by the controller. All PCT touch screens are made up of an electrode matrix of rows and columns. The capacitance can be changed at every individual point on the grid (intersection). It can be measured to accurately determine the exact touch location. All projected capacitive touch (PCT) solutions have three key features in common: the sensor as matrix of rows and columns; the sensor lies behind the touch surface; and the sensor does not use any moving parts.

In mutual capacitive sensors, there is a capacitor at every intersection of each row and each column. A 16-by-14 array, for example, would have 224 independent capacitors. A voltage is applied to the rows or columns. Bringing a finger or conductive stylus close to the surface of the sensor changes the local electrostatic field which reduces the mutual capacitance. The capacitance change at every individual point on the grid can be measured to accurately determine the touch location by measuring the voltage in the other axis. Mutual capacitance allows multi-touch operation where multiple fingers, palms or styli can be accurately tracked at the same time.

Self-capacitance sensors can have the same X-Y grid as mutual capacitance sensors, but the columns and rows operate independently. With self-capacitance, the capacitive load of a finger is measured on each column or row electrode by a current meter. This method produces a stronger signal than mutual capacitance, but it is unable to resolve accurately more than one finger, which results in “ghosting”, or misplaced location sensing.

An infrared touchscreen uses an array of X-Y infrared LED and photodetector pairs around the edges of the screen to detect a disruption in the pattern of LED beams. These LED beams cross each other in vertical and horizontal patterns. This helps the sensors pick up the exact location of the touch. A major benefit of such a system is that it can detect essentially any input including a finger, gloved finger, stylus or pen. IR sensors are generally used in outdoor applications and point of sale systems which can't rely on a conductor (such as a bare finger) to activate the touchscreen. Unlike capacitive touchscreens, infrared touchscreens do not require any patterning on the glass which increases durability and optical clarity of the overall system.

There are several principal ways to build a touchscreen. The key goals are to recognize one or more fingers touching a display, to interpret the command that this represents, and to communicate the command to the appropriate application.

In the most popular construction techniques, the capacitive or resistive approach, there are typically four layers: 1. a top polyester coated with a transparent metallic conductive coating on the bottom; 2. an adhesive spacer; 3. a glass layer coated with a transparent metallic conductive coating on the top; and 4. an adhesive layer on the backside of the glass for mounting. There are two infrared-based approaches. In one, an array of sensors detects a finger touching or almost touching the display, thereby interrupting light beams projected over the screen. In the other, bottom-mounted infrared cameras record screen touches. In each case, the system determines the intended command based on the controls showing on the screen at the time and the location of the touch.

The development of multipoint touchscreens facilitated the tracking of more than one finger on the screen. Thus, operations that require more than one finger are possible. These devices also allow multiple users to interact with the touchscreen simultaneously.

### SUMMARY OF THE INVENTION

The system and method of the present provide for improved accuracy in the detection of a stylus on a touch sensitive surface of an electronic device, such as a tablet. The system and method employ a dual method of detection that compliments each other to form a detection system can increase accuracy of the prior art several fold (e.g., 2 mm vs 0.2 mm) First a electromagnetic induction detection system provides a coarse (e.g., +/−2 mm) coordinate of the location of a stylus with respect to a screen of the electronic device. The course stylus coordinate is then used in the processing of a capacitive detection system that performs a subpanel capacitive scanning for the pen tip as it contacts the touch screen in the vicinity of the course stylus coordinate. The subpanel capacitive scanning yields the final stylus coordinate that is significantly (e.g., 1000%) more precise than that of the prior art.

Specifically, the electronic device detects the presence of the top of the stylus and provides the general coordinates of its position. Then, as touches occur on the surface of the device, e.g., the stylus tip as well as the various parts of the user's hand, the system uses the coordinates supplied from the electromagnetic induction detection to very quickly and accurately pinpoint the actual location of the stylus input on the surface of the device.

### BRIEF DESCRIPTION OF THE DRAWINGS

For the purposes of illustrating the present invention, there is shown in the drawings a form which is presently preferred, it being understood however, that the invention is not limited to the precise form shown by the drawing in which:

FIG. 1 illustrates a stylus according to the present invention;

FIG. 2 illustrates a user employing a stylus and tablet incorporating the present invention;

FIG. 3 depicts the capacitive sensing on the surface of the electronic device;

FIG. 4 illustrates the capacitive touch screen layer and the EMR layer and corresponding controllers;

FIG. 5 illustrates the components of an exemplary device; and

FIG. 6 is a flow chart outlining the basic operation of the present invention.

### DETAILED DESCRIPTION OF THE INVENTION

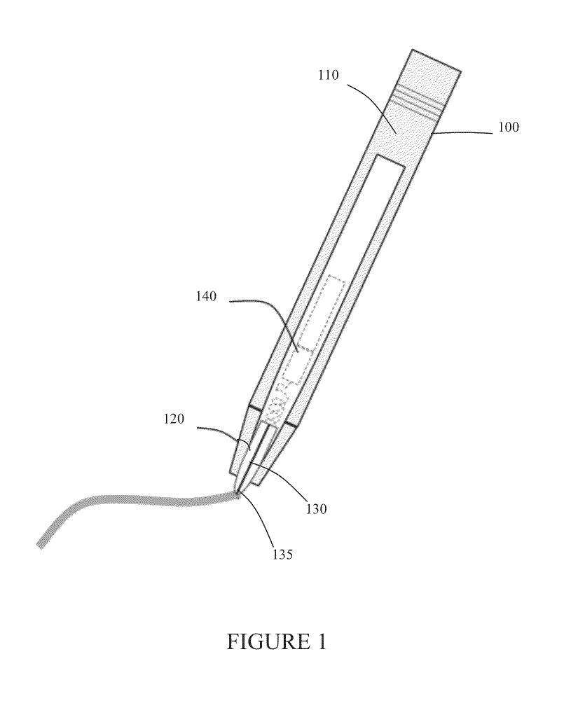

FIG. 1 illustrates a stylus 100 according to the present invention. The stylus includes a body 110 which is pen shaped for easy and comfortable holding by a user. Within the body 110 is a stylus tip 130. Tip 130 is preferably made from an optically clear and electrically conductive material. In a preferred embodiment, the tip is optically clear so that it can include a colored indicator line 130 that serves to aid the user in identifying and locating the actual tip 135 of the pen tip 120, which is the point where the stylus 100 actually contacts the surface of an electronic device.

Also included in body 140 is the electromagnetic induction circuitry 140 used to assist in the detection of the location of the pen tip 120 in relation to the surface of the electronic device. Typically, this electromagnetic induction circuitry 140 is formed from an inductor and a capacitor (LC) circuit. The LC circuit will resonate at a particular frequency when energized. Another form of electromagnetic circuit is formed under the surface of the electronic device and is typically is made up of conductive (e.g., copper) loops that create over-lapping antenna coils in both the X and Y directions. As these coils in the device are powered, they emit electromagnetic fields, Electromagnetic Resonance (EMR) signals, that are detected by the electromagnetic induction circuitry 140 in the stylus 100. Electromagnetic induction circuitry 140 can be either passive, i.e., powered by the fields generated by the electronic device, or active, i.e., separately powered, for example by battery.

Whether passive or active, the LC circuit in electromagnetic induction circuitry 140 is energized to radiate its own EMR field, typically at a specified frequency. The EMR from the electromagnetic induction circuitry 140 is reflected back toward the loops of the sensor buried under the surface of the electronic device. The sensor in the device can detect the EMR field, and thus the presence of the stylus 100 in both the X and Y directions. This X-Y coordinate data is then passed onto a controller tasked with processing user screen input.

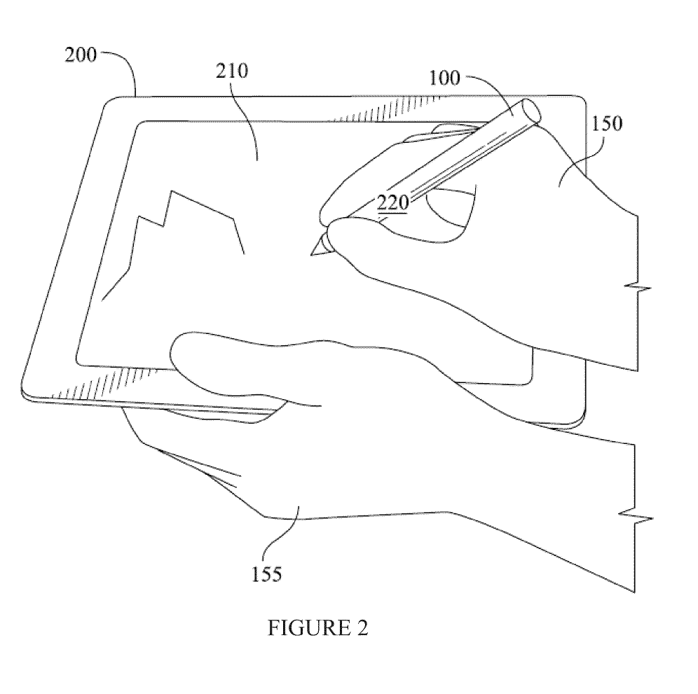

FIG. 2 depicts a user employing a stylus 100 and tablet 200 of the present invention in a conventional manner. If the user is right handed, she will typically hold the tablet in her left hand 155 and hold the stylus 100 in her right hand. In order to perform inking or other touch operations on the tablet 200, the user brings the stylus in contact with the touch screen 210 of the tablet 200.

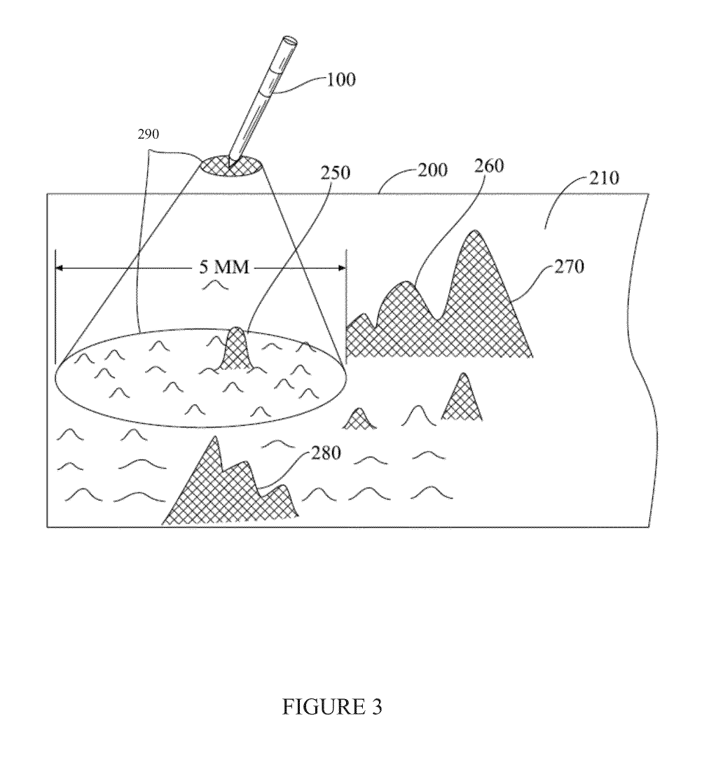

In addition to the imbedded electromagnetic circuitry/sensors as described above, in the preferred embodiment, the present invention also has the circuitry for capacitive touch sensing built into layer or layers under the top surface of the screen 210. As known in the art ands as described above, the capacitive touch screen 210 is able to detect touches made on the screen 210, either by a user's fingers or by a stylus 100. Unfortunately, as illustrated in FIG. 3, the screen 210 also detects other touches that are not intended by the user to convey input to the tablet 200.

FIG. 3 graphically illustrates the capacitive sensing on the surface 210 of the electronic device 200. The “peaks” 250-280 illustrated in this figure graphically represent the magnitude of the capacitive touches detected by the tablet 200 at the respective location on the touch screen 210. For example, peak 250 represents the touch of the stylus 100, peaks 260 and 270 are made by touches from the user's right hand 150 (FIG. 2) and peak 280 is caused by the user's thumb on her left hand 155 (FIG. 2) that is holding the tablet. More specifically, touch 260 is from the user's pinky finger, resting on the surface 210 of the tablet 200 while she is holding the stylus 100 and touch 270 is from the user's palm.

As can be seen by the plurality of touches that occur virtually simultaneously on the surface 210 when the user begins use of the stylus 100 for input, the control circuitry in the tablet 200 can have a difficult time identifying which of these various touches are caused by the stylus. This is one of the significant problems solved by the present invention. Prior to the user even touching the stylus to the surface 210, the electromagnetic circuitry in the tablet 200 and in the pen 100 cooperate as described above to allow the control circuitry in the tablet 200 to determine, approximately, the location of the pen relative to the surface 210.

As shown in FIG. 3, the system's approximation of the location of the tip of the stylus is represented by the circle 290. In a preferred embodiment, the diameter of this approximation circle is 5 millimeters. As appreciated by those skilled in the art, by providing the 5 mm circle of approximation with electromagnetic induction circuitry, the system of the present invention significantly reduces the area that is required to be searched to detect the capacitive touch of the stylus on the surface 210. This reduced area searching is known as subpanel scanning. Because of this reduced search area 290, the system and method of the present invention can locate the stylus touch significantly faster and with more accuracy than that of the prior art. This results in a significantly better user experience as the user does not have to wait at all for the device 200 to recognize the location of the stylus on the surface 210 and can begin her input (e.g., inking) immediately.

Experimentally, it has been determined that the a system incorporating the present invention's combination of the EMR detection and the capacitive touch detection can provide accuracy in determining the pen tip location down to 0.3 mm. In a presently preferred embodiment, the data from the EMR detection circuitry in the device 200 is fed to the controller for the capacitive touch screen 210. As described above, the capacitive touch screen controller can use the EMR detection data to limit the area in which it is searching for touches, looking for the touch corresponding to the pen tip.

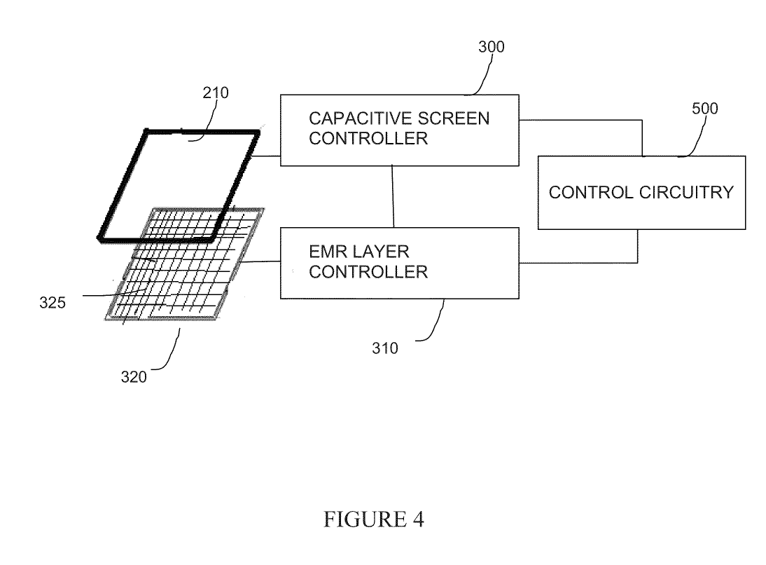

FIG. 4 conceptually illustrates the layers and circuitry that is preferably included in the device 200 for enabling the improved pen detection of the present invention. As described above, the device 200 preferably includes a capacitive touch screen layer 210. This layer 210 is capable of detecting user input on its surface, including, preferably, multitouch input. Touch sensitive devices using technology other than the preferred capacitive devices can be used, so long as they do not interfere with the operation of the EMR layer 320. The capacitive touch screen is controlled by the Capacitive Screen Controller 300. The primary purpose of the Controller 300 is to perform a scan of the output signals from the capacitive screen 210 in order to identify user input in the form of touches. The results of its analysis is forwarded to the main control circuitry (e.g., processor) 500 for the device 200.

The device 200 also includes an EMR layer 320, preferably formed below the capacitive layer 210. As described above, the EMR layer 320 is typically formed as a grid of elements 325. This grid 325 energized by the EMR Layer Controller 310 and emits an electromagnetic field. As described above, the electromagnetic field generated by the grid 325 is picked up by the electromagnetic induction circuitry 140 in the stylus 100 (see FIG. 1). The electromagnetic induction circuitry 140 in turn generates it own EMR field which is then detected by the grid of elements 325. In this manner, the EMR layer 320 can detect the presence of the pen 100. In an alternative embodiment, one grid 325 can be provided to generate the electromagnetic field that excited the pen 100, and a second, separate grid can be provided to

The detection signals from the EMR layer 320 are fed to the EMR Layer Controller 310 where they are processed. In a presently preferred embodiment, the processed detection signals (e.g., x-y coordinates, strength) are sent from the EMR Layer Controller 310 to the Capacitive Screen Controller 300 where they are used to create the subpanel scanning area 300. The output from the EMR Layer Controller 310 can also be fed directly to the Control Circuitry 500.

In one embodiment of the present invention, the capacitive screen unit layer 210 and the EMR layer 320 can be packaged as one integral unit for inclusion in a device 200. Further, the unit can contain either the EMR Layer Controller 310 or the Capacitive Screen Controller 300, or both, or an integrated controller that controls both the capacitive screen unit layer 210 and the EMR layer 320.

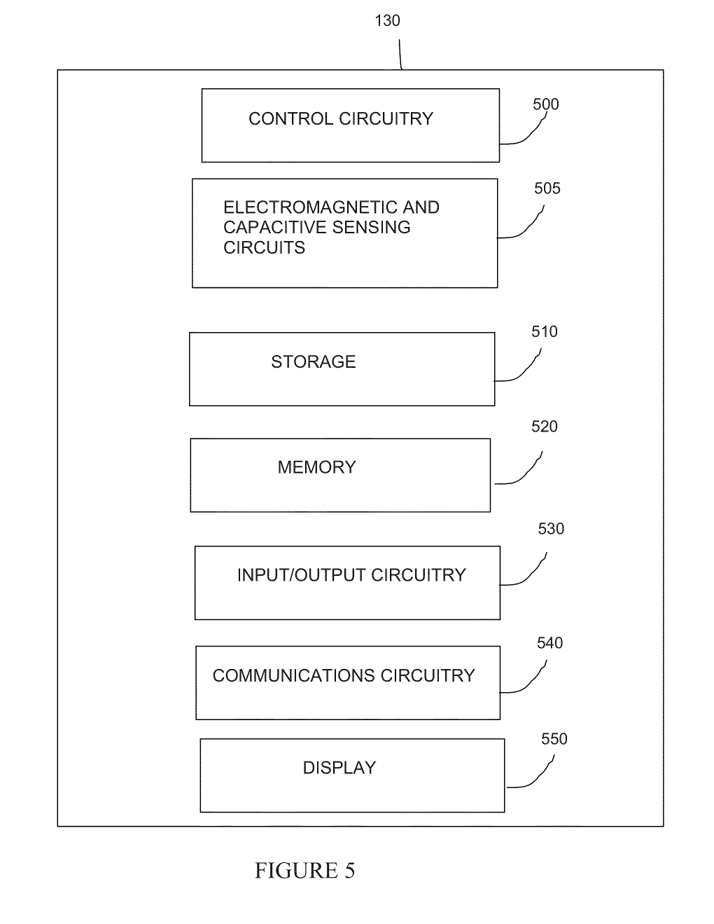

FIG. 5 illustrates an exemplary device 200. As appreciated by those skilled the art, the device 200 can take many forms capable of operating the present invention. As previously described, in a preferred embodiment the local device 200 is a mobile electronic device, and in an even more preferred embodiment device 200 is an electronic tablet device. Electronic device 200 can include control circuitry 500, storage 510, memory 520, input/output (“I/O”) circuitry 530, communications circuitry 540, and display 550. In some embodiments, one or more of the components of electronic device 200 can be combined or omitted, e.g., storage 510 and memory 520 may be combined. As appreciated by those skilled in the art, electronic device 200 can include other components not combined or included in those shown in this Figure, e.g., a power supply such as a battery, an input mechanism, etc.

Electronic device 200 can include any suitable type of electronic device. For example, electronic device 200 can include a portable electronic device that the user may hold in his or her hand, such as a digital media player, a personal e-mail device, a personal data assistant (“PDA”), a cellular telephone, a handheld gaming device, a tablet device or an eBook reader. As another example, electronic device 200 can include a larger portable electronic device, such as a laptop computer. As yet another example, electronic device 200 can include a substantially fixed electronic device, such as a desktop computer.

Control circuitry 500 can include any processing circuitry or processor operative to control the operations and performance of electronic device 200. For example, control circuitry 500 can be used to run operating system applications, firmware applications, media playback applications, media editing applications, or any other application. Control circuitry 500 can drive the display 550 and process inputs received from a user interface, e.g., the display 550 if it is a touch screen device.

The electromagnetic and capacitive sensing circuits 505 includes sensing hardware described above to enable both the electromagnetic sensing as well as the capacitive touch sensing. The electromagnetic and capacitive sensing circuits 505 are coupled to Input/Output circuitry 530 as well as the control circuitry 500 that controls the various input and output to and from the other various components.

Storage 510 can include, for example, one or more computer readable storage mediums including a hard-drive, solid state drive, flash memory, permanent memory such as ROM, magnetic, optical, semiconductor, paper, or any other suitable type of storage component, or any combination thereof. Storage 510 can store, for example, media content, e.g., eBooks, music and video files, application data, e.g., software for implementing functions on electronic device 200, firmware, user preference information data, e.g., content preferences, authentication information, e.g., libraries of data associated with authorized users, transaction information data, e.g., information such as credit card information, wireless connection information data, e.g., information that can enable electronic device 200 to establish a wireless connection, subscription information data, e.g., information that keeps track of podcasts or television shows or other media a user subscribes to, contact information data, e.g., telephone numbers and email addresses, calendar information data, and any other suitable data or any combination thereof. The instructions for implementing the functions of the present invention may, as non-limiting examples, comprise software and/or scripts stored in the computer-readable media 510.

Memory 520 can include cache memory, semi-permanent memory such as RAM, and/or one or more different types of memory used for temporarily storing data. In some embodiments, memory 520 can also be used for storing data used to operate electronic device applications, or any other type of data that can be stored in storage 510. In some embodiments, memory 520 and storage 510 can be combined as a single storage medium.

I/O circuitry 530 can be operative to convert, and encode/decode, if necessary analog signals and other signals into digital data. In some embodiments, I/O circuitry 530 can also convert digital data into any other type of signal, and vice-versa. For example, I/O circuitry 530 receives and converts the electromagnetic stylus detection and the user capacitive touch detection from the electromagnetic and capacitive sensing circuits 505 to signals that can be employed by the other components of the system. In an alternative embodiment, the actual conversion of the analog signals detected by the electromagnetic and capacitive members can be accomplished in the electromagnetic and capacitive sensing circuits 505 themselves. The digital data can be provided to and received from control circuitry 500, storage 510, and memory 520, or any other component of electronic device 200. Although I/O circuitry 530 is illustrated in this Figure as a single component of electronic device 200, several instances of I/O circuitry 530 can be included in electronic device 200.

Electronic device 200 can include any suitable interface or component for allowing a user to provide inputs to I/O circuitry 530. As described above it is intended that the touch screen 210 of the device is the main form of input from the user. However, electronic device 200 can include any other additional suitable input mechanism, such as a button, keypad, dial, or a click wheel.

In some embodiments, electronic device 200 can include specialized output circuitry associated with output devices such as, for example, one or more audio outputs. The audio output can include one or more speakers, e.g., mono or stereo speakers, built into electronic device 200, or an audio component that is remotely coupled to electronic device 200, e.g., a headset, headphones or earbuds that can be coupled to device 200 with a wire or wirelessly.

Display 550 includes the display and display circuitry for providing a display visible to the user. For example, the display circuitry can include a screen, e.g., an LCD screen that is incorporated in electronics device 200. In some embodiments, the display circuitry can include a coder/decoder (Codec) to convert digital media data into analog signals. For example, the display circuitry or other appropriate circuitry within electronic device can include video Codecs, audio Codecs, or any other suitable type of Codec.

The display circuitry also can include display driver circuitry, circuitry for driving display drivers, or both. The display circuitry can be operative to display content, e.g., media playback information, application screens for applications implemented on the electronic device 200, information regarding ongoing communications operations, information regarding incoming communications requests, or device operation screens, under the direction of control circuitry 500. Alternatively, the display circuitry can be operative to provide instructions to a remote display.

Communications circuitry 540 can include any suitable communications circuitry operative to connect to a communications network and to transmit communications, e.g., data from electronic device 200 to other devices within the communications network. Communications circuitry 540 can be operative to interface with the communications network using any suitable communications protocol such as, for example, Wi-Fi, e.g., a 802.11 protocol, Bluetooth, radio frequency systems, e.g., 900 MHz, 1.4 GHz, and 5.6 GHz communication systems, infrared, GSM, GSM plus EDGE, CDMA, quadband, and other cellular protocols, VOIP, or any other suitable protocol.

Electronic device 200 can include one more instances of communications circuitry 540 for simultaneously performing several communications operations using different communications networks, although only one is shown in this Figure to avoid overcomplicating the drawing. For example, electronic device 200 can include a first instance of communications circuitry 540 for communicating over a cellular network, and a second instance of communications circuitry 540 for communicating over Wi-Fi or using Bluetooth. In some embodiments, the same instance of communications circuitry 540 can be operative to provide for communications over several communications networks.

In some embodiments, electronic device 200 can be coupled to a host device such as digital content control server 150 for data transfers, synching the communications device, software or firmware updates, providing performance information to a remote source, e.g., providing riding characteristics to a remote server, or performing any other suitable operation that can require electronic device 200 to be coupled to a host device. Several electronic devices 200 can be coupled to a single host device using the host device as a server. Alternatively or additionally, electronic device 200 can be coupled to several host devices, e.g., for each of the plurality of the host devices to serve as a backup for data stored in electronic device 200.

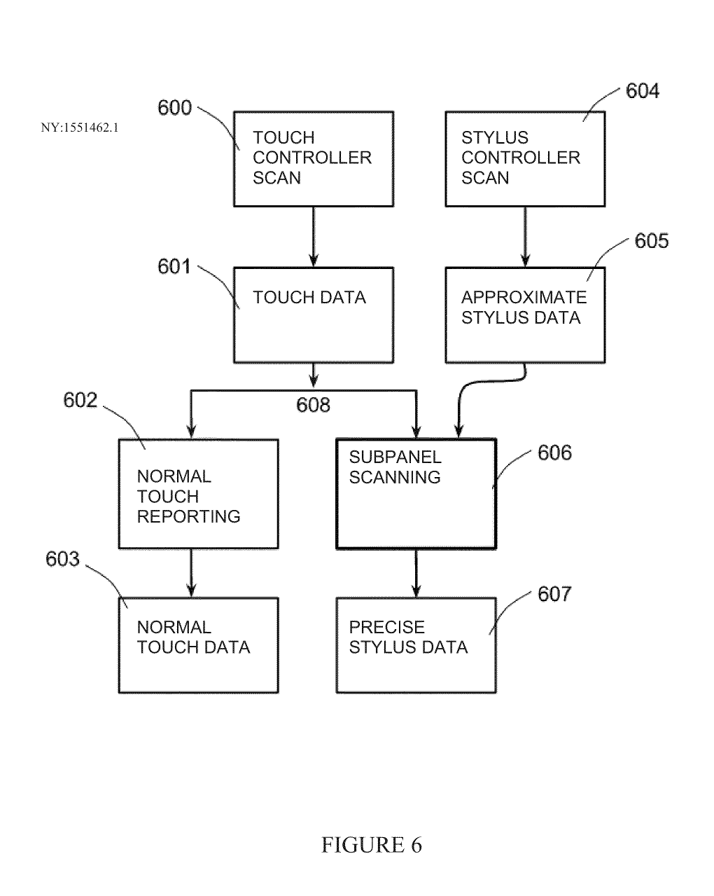

FIG. 6 is a flow chart outlining the basic operation of the present invention. In act 600, the touch controller 300 scans the touch screen 210 (FIG. 4). In act 604, the EMR controller 310 performs a scan the EMR layer 320 (FIG. 4). The acts respectfully generate touch data 601 and approximate stylus data 605. In act 608, it is determined if there is any stylus data that indicates the presence of the stylus near the surface of the touch screen 210. If there isn't a stylus detected, the touch screen controller 300 processes and reports the touch data to the control circuitry 500 (FIG. 5) in its normal way. This processing would occur, for example, when the user is flipping pages in an electronic document using gestures made with her fingers on the touch screen 210.

However, if a stylus is detected and the EMR controller 310 has fed the touch controller 300 the data representing the approximate location of the stylus 605, in the preferred embodiment, the touch controller 300 uses this data to create the search area 290 around the reported location of the stylus. As previously described, in the presently preferred embodiment, the EMR controller 310 is feeding the touch controller 300 the stylus data and the touch controller 300 performs the further processing. Other configurations of controllers are possible, such as the main processor 500 performing all of the analysis once the other controllers 300, 310 have gathered the data.

As described above, in act 606, the touch panel controller 300 performs a subpanel scanning of the touch data located in the reduced search are 290. The controller 300 does not have to perform an additional collection of data from the panel 210, but can merely limit its processing to the data contained in the reduced area 290. As further described above, using the reduced are 290, the touch controller 300 can quickly and easily isolate and identify, act 607, the touch that belongs to the stylus (see FIG. 3). This very precise location data is transmitted to the control circuitry for processing of the user's input that begins at this start location.

Although the present invention has been described in relation to particular embodiments thereof, many other variations and other uses will be apparent to those skilled in the art. It is preferred, therefore, that the present invention be limited not by the specific disclosure herein, but only by the gist and scope of the disclosure.

What is claimed is:

1. A method for sensing input on an electronic device, the device having electromagnetic sensors and capacitive sensors, the method comprising:
detecting a source of electromagnetism at a location on an input surface of the electronic device;
defining a search area around the location on the input surface;
detecting physical touches on the input surface;
processing only the physical touches that are detected within the search area;
identifying a touch corresponding to the source of the electromagnetism, the identified touch being at a start location on the input surface; and
receiving input at the start location.

2. The method of claim 1, wherein the electromagnetism is detected by an electromagnetism circuit in the electronic device, the method further comprising:
the electromagnetic circuit generating a first electromagnetic field;
receiving, by the source of electromagnetism, the first electromagnetic field;
generating, by the source of electromagnetism, a second electromagnetic field; and
wherein the act of detecting the source of electromagnetism further comprises detecting the second electromagnetic field.

3. The method of claim 1, wherein the source of electromagnetism is a stylus, the method further comprising:
generating, by the stylus, the electromagnetism by generating an electromagnetic field using a circuit containing an inductor and a capacitor.

4. The method of claim 3, the method further comprising:
the stylus passively generating the electromagnetic field from energy supplied by the electronic device.

5. The method of claim 3, further comprising:
the stylus actively generating the electromagnetic field from a power source in the stylus.

6. The method of claim 1, wherein the touches are detected by a capacitive circuit in the electronic device.

7. The method of claim 1, wherein the act of receiving input at the start location further comprises:
receiving written input beginning at the start location.

8. A system for sensing input, the system comprising:
a first layer containing a least one inductive circuit, the at least one inductive circuit detecting a source of electromagnetism at a location on the first layer;
control circuitry coupled to the first layer, the control circuitry defining a search area around the location;
at least one second layer containing at least one capacitive circuit, the at least one capacitive circuit detecting physical touches on an input surface of the second layer, the control circuitry being coupled to the second layer, the control circuitry processing only the physical touches that are detected within the search area;
wherein the control circuitry is operable to identify a touch corresponding to the source of the electromagnetism, the identified touch being at a start location on the input surface.

9. The system of claim 8, wherein the first layer, the control circuitry and the at least one second layer are formed in an integral unit

10. An electronic device comprising:
a display screen;
a memory that includes and instructions for operating the system;
at least one inductive circuit, the at least one inductive circuit detecting a source of electromagnetism at a location on an input surface of the display screen;
at least one capacitive circuit, the at least one capacitive circuit detecting physical touches on the input surface;
control circuitry coupled to the memory, coupled to the at least one inductive circuit, coupled to the at least one capacitive circuit and coupled to the display screen, the control circuitry capable of executing the instructions and is operable to at least:
define a search area around the location on the input surface based on information from the at least one inductive circuit;
process only the physical touches that are detected by the at least one capacitive circuit within the search area;
identify a touch corresponding to the source of the electromagnetism, the identified touch being at a start location on the input surface; and
receive input at the start location.

11. The electronic device according to claim 10, further comprising:
an electromagnetic circuit generating a first electromagnetic field that is used by the source of electromagnetism to generate a second electromagnetic field,
wherein the inductive circuit detects the source of electromagnetism by detecting the second electromagnetic field.

12. The electronic device according to claim 11, wherein the inductive circuit and the electromagnetic circuit are the same circuit

13. The electronic device according to claim 10, further comprising:
a stylus, wherein the source of electromagnetism is the stylus, the stylus further comprising:
a circuit containing an inductor and a capacitor, the circuit generating the electromagnetism by generating an electromagnetic field.

14. The electronic device according to claim 13, wherein the stylus is a passive stylus, passively generating the electromagnetic field from energy supplied by the electronic device.

15. The electronic device according to claim 13, further comprising:
a power source in the stylus, where in the stylus actively generates the electromagnetic field using the power source.

16. The electronic device according to claim 10, wherein the control circuitry executing the instructions is further operable to:
receive written input beginning at the start location.

17. The electronic device according to claim 10, wherein the at least one capacitive circuit is a touch screen, the device further comprising:
a touch screen controller coupled to the touch screen, the touch screen controller controlling operation of the touch screen.

18. The electronic device according to claim 10, further comprising:
an electromagnetic controller coupled to the inductive circuit, the electromagnetic controller controlling operation of the inductive circuit.

19. The electronic device according to claim 10, wherein the at least one capacitive circuit is a touch screen, the device further comprising:
a touch screen controller coupled to the touch screen, the touch screen controller controlling operation of the touch screen; and
an electromagnetic controller coupled to the inductive circuit, the electromagnetic controller controlling operation of the inductive circuit.

20. The electronic device according to claim 19, where the electromagnetic controller is coupled to the touch screen controller.
